(19) United States
(12) Patent Application Publication
(10) Pub. No.: US 2005/0144098 A1
(43) Pub. Date: Jun. 30, 2005

(54) Methods and systems for fund raising

(75) Inventors: Joseph E. Vance, Roseville, MN (US); Cedric L. Dean, Brooklyn Park, MN (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Qwest Communications International Inc., Denver, CO (US)

(21) Appl. No.: 10/741,587

(22) Filed: Dec. 19, 2003

(51) Int. Cl. G06F 17/60

(52) U.S. Cl. 705/35; 705/14

(57) ABSTRACT

Various embodiments of the invention provide methods and systems for raising funds for organizations, and in particular cases, non-profit organizations. Merely by way of example, one set of embodiments provides, in a relationship between a product provider and a non-profit organization, a method of providing funding for the non-profit organization. Another set of embodiments includes systems which can, in a relationship between a product provider and an organization (including, for example, a non-profit organization), provide funding under a fund raising program for the organization. Such systems can comprise a processor, an interface in communication with the processor, and a computer readable medium in communication with the processor. The interface can be configured to interact with a user. Merely by way of example, the interface can comprise a web interface and/or a telephonic interface (which may include an integrated voice response system).

### BACKGROUND OF THE INVENTION

This invention relates generally to non-profit organizations and specifically to fund-raising activities for such organizations.

Non-profit organizations generally face significant operating costs, and, by their nature often have difficulty raising funds to defray these costs. Such organizations historically have employed a variety of fund raising activities to generate such funds. For example, organizations often conduct fund raising drives, telethons, and the like, depending on the generosity of benefactors for their existence.

Some organizations sell various products to generate funds. Common examples of such programs include bake sales, raffles and the like. Other organizations attempt to partner with commercial entities, attempting to sell the commercial entity's products, with a portion of the sales proceeds going to the organization. By way of example, an organization may sell magazine subscriptions on behalf of a magazine publisher, and the publisher may provide a commission to the organization for each subscription sold. While such activities may sometimes be effective, their utility is limited, in part by the nature of products that may be sold in this manner.

Merely by way of example, most consumers are unwilling to buy anything but inexpensive products (e.g., food products, magazine subscriptions) from an organization member canvassing neighborhoods door-to-door, since the member will be unlikely to provide a description of the goods sold with any sort of precision or reliability. Further, the canvassing activities may actually prove counterproductive. For example, potential donors may be disgruntled by a knock at the door during the dinner hour by a member of an organization seeking to sell magazine subscriptions, resulting in a loss of goodwill toward both the organization and the provider of the products being offered. In addition, while a potential donor may be interested in helping the organization, that donor may have little interest in purchasing candy bars, magazines and the like that she otherwise does not need. Such distribution models also generally suffer from inefficiencies and administrative difficulties: among other things, canvassing neighborhoods with a placard advertising products often results in a relatively low sales rate, and fulfillment of orders placed often requires the organization's member to re-circulate the neighborhood to deliver the products. Likewise, administration of the fund raising program (including activities such as transmitting a list of customers/products purchased, handling funds received from customers, and the like) often presents difficulties.

What is needed therefore, is a more robust vehicle for allowing organizations to partner with product providers to sell products the public generally is interested in purchasing. Ideally, such a system would allow for efficient generation of sales leads for the product provider; further, it would be beneficial if potential customers were allowed contact with the product provider itself, allowing the potential customers to investigate offered products and/or choose products of the greatest value to them. In this way, relatively more sales could be transacted—generally resulting in relatively greater revenues for provider and correspondingly greater funds generated for the organization—and customers would be more satisfied with the products they purchased, resulting in goodwill toward both the provider and the organization, and a greater potential for future sales.

### BRIEF SUMMARY OF THE INVENTION

Various embodiments of the invention provide methods and systems for raising funds for organizations, and in particular cases, non-profit organizations. Merely by way of example, one set of embodiments provides, in a relationship between a product provider and a non-profit organization, a method of providing funding for the non-profit organization. In some embodiments, the method comprises providing a computer interface between a user device and a processing system. The user device can be a computer, telephone, etc., and the computer interface therefore can be a software interface, a web interface, a telephonic interface (perhaps comprising an integrated voice response system), a human operator conversing with a member of the organization and inputting received data into a computer, and/or the like.

The computer interface can allow a member of the non-profit organization to register information about a sales lead who may have an interest in a product offered by the provider, and the information can include contact information for that sales lead. In certain cases, the product can comprise a telecommunication service. The sales lead may have been contacted by the organization and/or its member(s) to discuss the products prior to the registration of that sales lead's information. The contact information can include any of a variety of types of information. Merely by way of example, the contact information can comprise an electronic mail address, a telephone number, a postal address and/or the like. In certain embodiments, the method can include providing an incentive to the organization and/or the member based on the sales lead information. Merely by way of example, an incentive may be provided to the non-profit organization if the registered contact information comprises an electronic mail address.

In accordance with some embodiments, the registered contact information can be validated, perhaps using one or more procedures explained in detail below. In other embodiments, a partner application can be accepted from the organization. If desired, the partner application can be electronic, such as an online form, data input by telephone, etc. Further, the non-profit status of the organization can be verified, optionally before allowing the registration of any contact information.

The method can further comprise electronically contacting the sales lead to invite the sales lead to engage in a transaction regarding one or more offered products in which the sales lead may have an interest. The contact can be made using the registered contact information, such that, for example, if the registered contact information comprises an electronic mail address, the sales lead can be contacted by electronic mail transmitted to the registered address. If the sales lead chooses to engage in a transaction, the method may comprise processing an automated transaction regarding the offered product. In some cases, the offered product(s) may be a plurality of products, and the sales lead can be allowed to choose at least one product from the plurality of products, and processing an automated transaction therefore can comprise processing an automated transaction regarding the chosen products.

In accordance with certain embodiments, if the transaction is processed, funds may be contributed to the organization, and the amount of the contribution can depend on the processed transaction. The contribution may be made on a per-transaction basis and/or contributions from multiple transactions may be made in a single contribution. The contribution can comprise currency, credit towards the provider's products and/or the like. In some cases, a minimum commitment may be required from the sales lead before contributing funds to the non-profit organization. Merely by way of example, the minimum commitment can comprise a minimum total product price and/or a commitment to ongoing purchases of the offered product(s) for a minimum duration. In other embodiments, the method can comprise providing a status of the automated transaction.

In some cases, a remedial action can be taken upon notification that the sales lead did not express to the organization an interest in any products offered by the provider. The remedial action can comprise notifying the organization of this fact, warning the organization that submission of additional sales leads having no interest in any products offered by the provider will result in the imposition of a penalty and/or imposing a penalty against the organization. The penalty can comprise a deduction against funds contributed to the organization, disallowing the organization and/or certain of its members from submitting any additional sales leads for at least a certain period of time, and/or terminating the organization's participation in the fund raising program.

Another set of embodiments includes systems which can, in a relationship between a product provider and an organization (including, for example, a non-profit organization), provide funding under a fund raising program for the organization. Such systems can comprise a processor, an interface in communication with the processor, and a computer readable medium in communication with the processor. The interface can be configured to interact with a user. Merely by way of example, the interface can comprise a web interface and/or a telephonic interface (which may include an integrated voice response system). The computer readable medium can comprise instructions executable by the processor to perform any of the methods discussed above.

The invention has been briefly summarized above. Those skilled in the art may ascertain additional benefits and features attendant to various embodiments of the invention by reference to the Figures, which are described in detail below.

### BRIEF DESCRIPTION OF THE DRAWINGS

FIG. 1 illustrates a system that can be used to raise funds for a non-profit organization in accordance with various embodiments of the invention.

FIG. 2 illustrates a computer system that can be used to raise funds for a non-profit organization in accordance with various embodiments of the invention.

FIGS. 3A and 3B collectively illustrate a method of registering a non-profit organization for a fundraising program and raising funds for the non-profit organization in accordance with embodiments of the invention.

### DETAILED DESCRIPTION OF THE INVENTION

The figures illustrate one or more exemplary embodiments of the invention, which are described in detail in the remaining portions of the specification. In the figures, like reference numerals are used throughout to refer to similar components. In some instances, a sub-label consisting of a lower case letter is associated with a reference numeral to denote one of multiple similar components. When reference is made to a reference numeral without specification to an existing sub-label, it is intended to refer to all such multiple similar components.

Embodiments of the invention provide novel ways for members of non-profit organizations (“NPO”) to raise funds for their organization. In accordance with certain embodiments, an NPO (and/or a member of an NPO) may register with a product provider to raise funds by referring sales leads to that provider, in return for a commission, referral fee, etc. on sales generated through those leads. As used herein, the term “sales lead” means any entity (e.g., a person, company, etc.) that may be willing to consider purchasing one or more products from a product provider. In some cases, the sales lead may have expressed a willingness to purchase one or more of the services in order to benefit the NPO. In other cases, the sales lead may be a contact (including, inter alia, a friend, family member, business associated) of a member of the NPO. In still other cases, the provider may offer discounts or other incentives to sales leads, in order to encourage purchases that would benefit the NPO. In this way, the provider may attract reliable sales leads, and members of the NPO can raise funds for their organization.

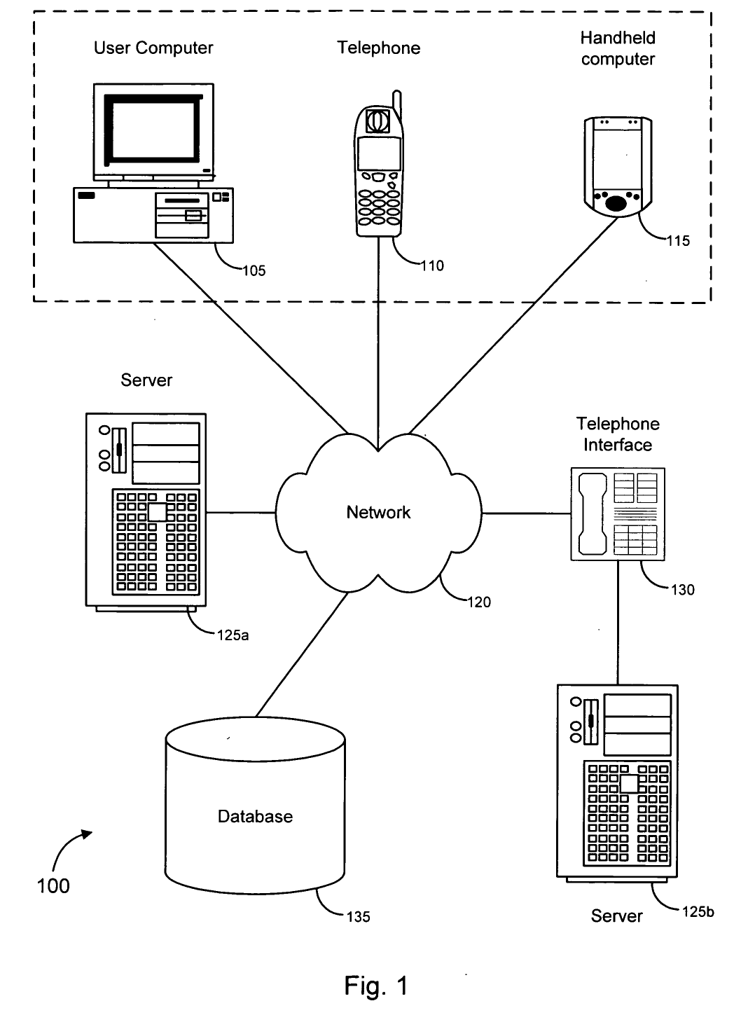

Turning now to the figures, several exemplary embodiments of the invention will be described in detail. For instance, FIG. 1 illustrates a schematic diagram of a system 100 that can be used in accordance with one set of embodiments. The system 100 can include one or more user devices 105, 110, and 115, which, purely for illustrative purposes, are shown on FIG. 1 as a user computer 105, a telephone 110 and a handheld computer 1115. The user devices 105, 110, and 115 can comprise any device capable of data and/or voice communication. Exemplary user devices can include general purpose personal computers (e.g., 105) (including, merely by way of example, personal computers and/or laptop computers running any appropriate flavor of Microsoft Corp.'s Windows™ and/or Apple Corp.'s Macintosh™ operating systems) and/or workstation computers running any of a variety of commercially-available UNIX™ or UNIX-like operating systems. Alternatively, the user devices 105, 110, and 115 can be any other electronic device, such as a thin-client computer, POTS telephone, wireless telephone (e.g., 110), Internet-enabled mobile telephone, handheld computer and/or personal digital assistant (e.g., 115), capable of voice and/or data communication, including merely by way of example communication via a computer network and/or displaying and navigating web pages or other types of electronic documents. These user devices 105, 110, 115, depending on their capabilities, can also have any of a variety of applications, including one or more database client and/or server applications, and/or web browser applications. Although the exemplary system 100 is shown with three user devices, any number of user computers can be supported.

Certain embodiments of the invention operate in a networked environment, including a network 120. The network 120 can be any type of network familiar to those skilled in the art that can support data communications using any of a variety of commercially-available protocols, including without limitation TCP/IP, SNA, IPX, AppleTalk, and the like. Merely by way of example, the network 120 can be a local area network (“LAN”) including without limitation an Ethernet network, a Token-Ring network and/or the like; a wide-area network; a virtual network, including without limitation a virtual private network (“VPN”); the Internet; an intranet; an extranet; a telephone network, including without limitation a public switched telephone network (“PSTN”), a wireless telephone network, a private branch exchange (“PBX”) and/or the like; an infra-red network; a wireless network, including without limitation a network operating under any of the IEEE 802.11 suite of protocols, the Bluetooth™ protocol known in the art, and/or any other wireless protocol; and/or any combination of these and/or other networks.

Embodiments of the invention can include one or more server computers 125 which can serve as processing systems in accordance with certain embodiments of the invention. Merely by way of example, a server 125 may be a web server, which can used to process requests for web pages or other electronic documents from user devices 105, 110, and 120. The servers 125 each can be running an operating system, including without limitation any of those discussed above, as well as any commercially-available server operating systems, including, merely by way of example, OS/390™, OS/400™, VMS™, UNIX™ (including any of its varieties and/or similar variants), and the like. The servers 125, 130 can also run a variety of server applications, including HTTP servers, FTP servers, CGI servers, database servers, Java servers, and the like.

Servers 125 can also include one or more file servers, application servers and/or transaction processing servers, which can, in addition to an operating system, include one or more applications accessible by a client running on one or more of the client devices 105, 110, 115. Merely by way of example, the server(s) 125 can be one or more general purpose computers capable of executing programs or scripts in response to requests from and/or interaction with the user devices 105, 110 and 115, including without limitation web applications. Such web applications can be implemented as one or more scripts or programs written in any programming language, such as Java™, C, or C++, or any scripting language, such as Perl, Python, or TCL, or any combination thereof. The servers 125 can also include database servers, including without limitation those commercially available from Oracle, Microsoft, Sybase™, IBM™ and the like, which can process requests from database clients running on a user device (e.g., 105). In some embodiments, one or more servers 125 can create web pages dynamically for performing methods of the invention. These web pages can serve as an interface between the user devices 105, 110, 115 and the servers 125. Alternatively, a server 125 may run a server application, while a user device (e.g., 105) can run a dedicated client application. The server application, therefore, can serve as an interface for the user device running the client application.

In some implementations, a server 125b may include a telephone interface 130, which can allow the server to interact with an ordinary (POTS) telephone. The telephone interface 130, which may be implemented in software and/or hardware embodied in the server 125 and/or in a separate device in communication with the server, can provide integrated voice response (“IVR”) features familiar to those skilled in the art. The telephone interface also can be configured to interpret dual tone multi-frequency (commonly known as “DTMF” or “Touchtone®”) tones as data input. Thus, in accordance with embodiments of the invention, the telephone interface 130 can allow for a user to interact with a server 125b via voice and/or DTMF commands.

In certain embodiments, the system can include a database 135. The location of the database 135 is discretionary: it can reside on a storage medium local to (and/or resident in) one or more of the computers and/or user devices 105, 110, 115, 125. Alternatively, it can be remote from any or all of the computers 105, 110, 115, 125, so long as it is in communication (e.g., via the network 120) with one or more of these. In a particular set of embodiments, the database 135 can reside in a storage-area network (“SAN”) familiar to those skilled in the art. (Likewise, any necessary files for performing the functions attributed to the devices and/or computers 105, 110, 115, 125 can be stored locally on the respective computer and/or remotely, as appropriate.) In an embodiment, the database 135 can be a relational database, that is adapted to store, update, and retrieve data in response to SQL-formatted commands.

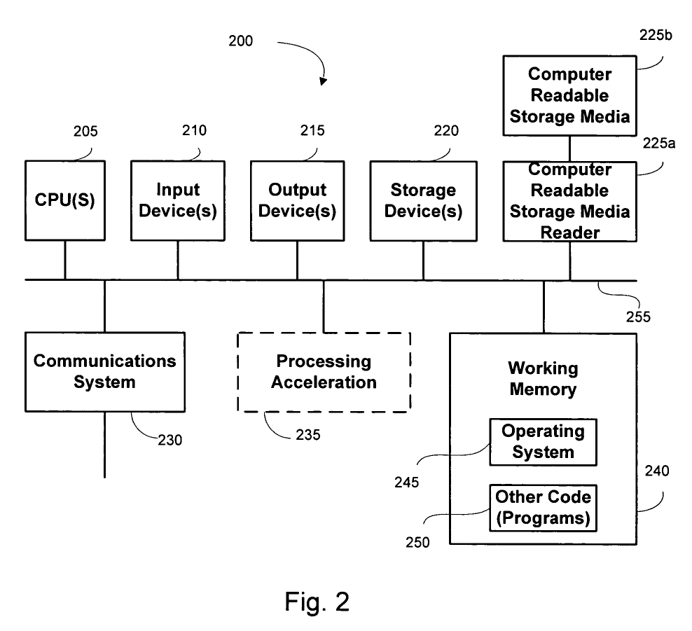

FIG. 2 provides a schematic illustration of one embodiment of a system 200 that can perform the methods of the invention and/or the functions of a user device and/or server computer, as described herein. This figure broadly illustrates how individual system elements may be implemented in a relatively separated or relatively more integrated manner. The system 200 is shown comprising hardware elements that can be coupled electrically via a bus 255, including a processor 205; an input device 210, which can include without limitation a mouse, a keyboard, a numeric keypad, a tablet and/or the like; an output device 215, which can include without limitation a speaker, a display device, a printer and/or the like; a storage device 220, which can include without limitation a disk drive, an optical storage device, solid-state storage device such as a random access memory (“RAM”) and/or a read-only memory (“ROM”), which can be programmable, flash-updateable and/or the like; a computer-readable storage media reader 225a; a communications system 230; which can include without limitation a modem, a network card (wireless or wired), an infra-red communication device, a wireless transceiver and/or antenna, and/or the like; a processing acceleration unit 235, which can include a DSP, a special-purpose processor and/or the like; and a memory 240, which can include a RAM or ROM device, as described above.

The computer-readable storage media reader 225a can further be connected to a computer-readable storage medium 225b, together (and, optionally, in combination with storage device(s) 220) comprehensively representing remote, local, fixed, and/or removable storage devices plus storage media for temporarily and/or more permanently containing computer-readable information. The communications system 230 may permit data to be exchanged with the network 120 and/or any other computer described above with respect to the system 100.

The computer system 200 also can comprise software elements, shown as being currently located within a working memory 240, including an operating system 245 and other code 250, such as an application program described above and/or designed to implement methods of the invention. It will be apparent to those skilled in the art that substantial variations may be made in accordance with specific requirements. For example, customized hardware might also be used and/or particular elements might be implemented in hardware, software (including portable software, such as applets), or both. Further, connection to other computing devices such as network input/output devices may be employed.

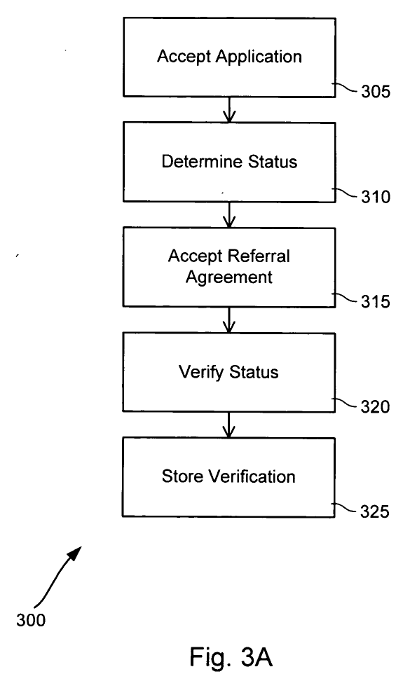

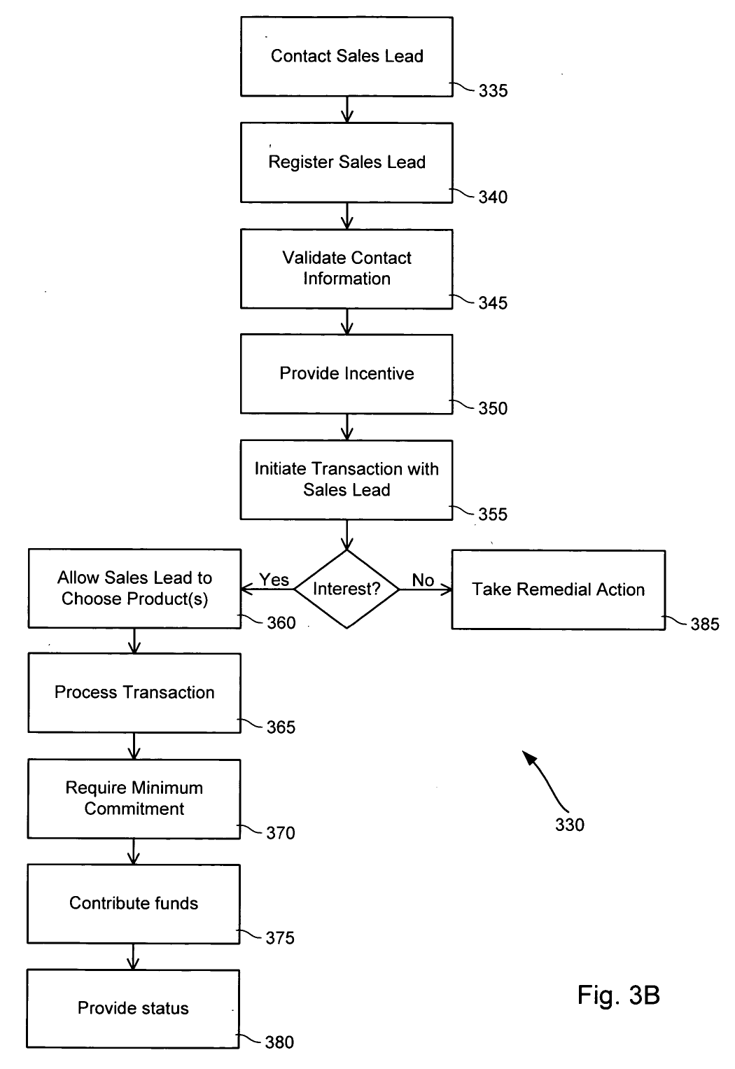

As mentioned above, certain embodiments of the invention provide methods for allowing an organization to raise funds. One set of embodiments is illustrated collectively by FIGS. 3A and 3B. It should be noted that, although certain of these embodiments are illustrated organizationally by the process flow diagrams on FIGS. 3A and 3B for purposes of description, unless the context clearly dictates otherwise, each of the illustrated procedures may be performed in an order different than illustrated and/or may be omitted entirely, depending on the embodiment. In accordance with certain methods of the invention, an organization can be registered for a fundraising program operated by the provider, and funds may be raised by the provider and the organization in cooperation under the program.

FIG. 3A illustrates a method 300 of registering an organization for a fundraising program, which can allow the organization to raise funds, for instance by facilitating the sale of a provider's products. In certain embodiments, therefore, the method 300 may be performed by a computer system (including those described above) operated by and/or on behalf of a provider. In accordance with some embodiments, an application can be accepted by the provider (block 305). In some embodiments, the application can be an online form (e.g., provided as part of a web page), and accepting the application can comprise allowing a user to submit the form. In other embodiments, the application can be a paper form, and accepting the application can comprise receiving the form (via mail, fax, etc.), converting the form to an electronic format (via manual input, scanning, optical character recognition (OCR)), etc. In still other embodiments, the application can be accepted by telephonic communication (via operator assistance and data input, DTMF interpretation, speech-to-text conversion, etc.). In many cases, accepting the application can include verifying that all necessary information (including, for instance, the name and/or contact information for the organization, the products the organization is interested in promoting, different fund raising options and the like) was provided by the applicant. Alternatively, the application can be a streamlined process, whereby the organization simply states that it is (or is not) an NPO, and a detailed application and/or registration form can be accepted at another point in the process, for instance, after the organization has executed a referral license agreement (described below with respect to block 315).

Accepting the application can further include saving a record of the application and/or any pertinent information thereon. The record can be saved in a database, including without limitation a relational database, such that the information easily and quickly may be recalled at later times (for instance, to allow for the automatic entry of redundant information into online forms and the like). In addition, information relating to sales leads, sales made under the organization's fund raising program, commissions and referral fees, etc. can be saved with and/or related to the saved application/registration information. Those skilled in the art can appreciate how the use of a relational database (perhaps with a plurality of tables, including without limitation tables storing organization information, sales lead information, sales information, referral fee information and the like) can facilitate the methods described herein.

At block 310, the status of the organization can be determined. For instance, the application may have a field requiring the applicant to state whether the organization is a non-profit organization (e.g., has been accorded non-profit status by the IRS, etc.), and determining the status of the organization can comprise analyzing the contents of this field to determine whether the organization is an NPO. Alternatively and/or in addition, the application can require the applicant to answer one or more questions about the organization that can be used to determine the status of the organization (e.g., accounting practices, purpose of the organization, etc.), and the answers to these questions can be used to determine the status of the organization. If the organization is determined to be an NPO, the method 300 can proceed; otherwise, the organization can be offered the opportunity to license the technology to provide fund raising to NPOs through the promotion of that organization's products.

Once the organization's status has been determined, the organization can execute a referral agreement, which can be accepted by the provider (block 315), for instance, in the manner described above with respect to the application. Specifically, the referral agreement can include terms relating to the types of products to be promoted by the organization, which sales by the provider will be eligible for fundraising under the referral program, the method used to calculate the funds generated for the organization (e.g., referral fees, commission rates, etc.) under the referral program and the like.

At block 320, the organization's status as an NPO can be verified (block 320). Verification of the organization's status can comprise providing a fax number and/or email address for the organization to send one or more verifying documents to the provider; the verifying document can be examined (manually and/or automatically) to determine whether it does in fact verify the organization's status. A verifying document can be any document recognized by those skilled in the art as a reliable confirmation of an organization's non-profit (and/or not-for-profit) status, including without limitation an affidavit executed by an authorized individual certifying that the organization is indeed an NPO, a document filed by the organization with a local, state and/or federal government agency (e.g., the IRS) certifying, applying for and/or electing non-profit status, and/or a document produced by a governmental agency confirming and/or awarding non-profit (and/or not-for-profit) status to that agency. Merely by way of example, a copy of IRS Form 1023 can, in some cases, serve as a verification document. Hence, examination of the verifying document can comprise analyzing the document for apparent authenticity as well as inspecting the document for relevant identifying information (the name of the organization, an identifier used by a government agency to identify the organization, etc.).

In accordance with other embodiments, verification of the organization's status may be accomplished without requiring input from the organization. For instance, if the organization, in its application, provided an identifier (e.g., an employer identification number (“EIN”)), a database of such identifiers may be consulted to determine whether that identifier is indeed associated with the organization and/or if the organization associated with that identifier has been accorded NPO status by a government agency. The database can be maintained by the provider and/or a third party, such as a governmental agency, credit reporting agency, investigative firm and/or the like. In some cases, the identifier may itself be sufficient to identify the organization as an NPO (e.g., some types of identifier may only be accorded to NPOs and/or may include a unique prefix, etc. that identifies the holder of that identifier as an NPO), and verifying the status of the organization can comprise merely verifying that the identifier is in fact associated with the organization.

Once the status of the organization as an NPO has been verified, a record of that verification can be saved. In certain embodiments, the organization's application/registration information can be saved (e.g., in a relational database, as described above), and the record of the verification can be saved with and/or related to the organization's application/registration information. The record of the verification can include an electronic image (e.g., formatted using any of several recognized image formats, including without limitation the TIFF and PDF file formats known in the art) and/or information obtained from a verifying document (e.g., a verifying document may be processed with OCR software and relevant information, such as organization name, identifier, etc. can then be saved in one or more fields in a database record). Saving the verification information, therefore, can assist the provider in accounting for the funds earned by/contributed to the organization as part of the fund raising program.

Turning now to FIG. 3B an exemplary method 330 illustrates how an organization (including, for example, an organization registered with a provider in accordance with a method such as the method 300 discussed above) may raise funds in accordance with embodiments of the invention. One or more components of the method 330 may be implemented electronically by a provider's system, including without limitation a system as discussed above with respect to FIGS. 1 and 2. The method 330 can comprise contacting a sales lead 335. In some cases, the organization (or a member thereof) will contact a sales lead, who may be a friend, relative, associate, etc. of the member. Contacting the sales lead can comprise any suitable form of communication between the organization (and/or its members) and the sales lead. Merely by way of example, communication contacting the sales lead can comprise personal conversation, telephone communication, electronic mail, and/or the like between a member of the organization and another party. In other cases, the organization can contact sales leads directly through flyers, mailings, electronic mail, etc. In particular cases, the sales lead may be a donor to the organization, and the organization may contact the sales lead through a fundraising drive, telethon and/or the like.

In any case, when the organization (and/or its members) contacts the sales lead, the organization can inform the lead of the organization's participation in a the fundraising program and inquire whether the sales lead would like to purchase any products from the provider as part of the program. Optionally, the organization can inform the sales lead that purchases through the program will benefit the organization and/or the organization can describe the various products offered by the provider in conjunction with the program. If the sales lead indicates a possible interest in purchasing services under the program, the organization can note that interest and/or the contact information for that lead. Contact information can include a telephone number, postal address, electronic mail address, etc. as well as, in some cases, the types of products in which the lead indicated interest. In some cases, a specific form (which may be provided to the organization by the provider) can be used to record the information.

The method can further include registering the sales lead (and/or the sales lead's contact information) with the provider (block 340). In some cases, registering the sales lead can comprise transmitting the information about the sales lead and/or its contact information obtained through the contact made by the organization in block 335. In other cases, however, the sales lead need not be contacted prior to registering the lead and/or its contact information. Merely by way of example, an organization may register contact information for a number of regular donors without first contacting those donors, on the assumption that the donors might be interested in learning about this additional way in which they may help raise funds for the organization.

Registering a sales lead can take a variety of forms. Merely by way of example, sales lead information can be registered electronically by a member of the participating organization. In some embodiments, the member can log on to a web site maintained by the provider (which may be the same web site used to register the organization, as described with respect to method 300) to register the contact information. (In certain implementations, for example, an organization can identify certain of its members to the provider, such that a member is provided with a user id, which, when used to log on to the web site, automatically associates that member (and the sales leads registered by the member) with the organization.) After logging on, the member can be provided a form with fields to accept various types of contact information, including the information described above. The member may, but need not, provide information pertaining to multiple contact methods for the lead (e.g., telephone number, fax number, email address, etc.). Optionally, if information about more than one contact methods is provided, the member can be allowed to specify a preferred contact method for the sales lead, such that the provider should attempt to contact the lead primarily by the preferred method. In some cases, the organization/member may have obtained the lead's agreement to purchase certain products, and registering the lead can further comprise identifying those products. Alternatively, the sales lead may be allowed to choose the products later in the transaction, as described below. In some cases, the member may register a lead's contact information by phone, for instance through interaction with an IVR and/or DTMF interpreter or by speaking with an operator at the provider, by fax and/or the like.

In some cases, the organization or its members may register sales leads in bulk. Merely by way of example, if a form was used to record contact information (as discussed above), that form may be submitted (either in paper format or electronically) to the provider, and all of the sales leads on the form may be registered by the provider manually and/or automatically. As another example, the organization may provide a list of sales leads (e.g., frequent donors, etc.) with contact information. The list may be provided in any proprietary or commonly-accepted format (e.g., XML file, spreadsheet file, database file, and/or the like), and that list may be imported into a processing system operated by the provider, thereby registering those sales leads. In some cases, registration procedures that require manual intervention by the provider (including, for example, data entry, operator assistance, etc.) may reduce the amount and/or rate of funds contributed by the provider to the organization. In this way, for instance, the provider can recover labor costs and/or incent the organization to use relatively more automated registration procedures.

After a sales lead has been registered with the provider, the provider optionally may validate that lead's contact information (block 345). Validation can be any process whereby the contact information is checked for apparent (and/or actual) validity. Merely by way of example, validation can be algorithmic (e.g., checking to see whether a registered email address appears to be valid by checking for the presence of an “@” symbol and a domain and/or checking a telephone number to ensure that the correct number of digits were supplied) and/or investigatory (e.g., indexing a provided telephone number against a telephone number database or directory to check whether the number is associated with the name of the sales lead). In some cases, validation can occur concurrently (or near-concurrently) with registration. For instance, when a member provides a telephone number on a web-based form, that number may be validated before the member is allowed to submit the form for registration. Alternatively and/or in addition, validation can occur after registration, and a failure message may be sent to the organization/member for any leads whose information could not be validated, indicating the need for updated information before the lead can be provided products under the fundraising program.

In accordance with certain embodiments, incentives can be provided to the organization in relation to the registration of sales lead contact information. For example, an organization may be accorded an incentive upon reaching certain thresholds in registering sales leads (e.g., 100 sales leads registered), in some cases regardless of whether those leads end up purchasing services under the program. In addition, an organization may be accorded an incentive based on the qualities of the sales leads and/or contact information provided. Merely by way of example, if a particular contact method (e.g., electronic mail) tends to be a more efficient and/or effective means of contacting the sales leads, an incentive may be awarded to the organization for each lead registered in which that contact method is designated the preferred (or only) contact method. Such incentives can take a variety of forms, including cash payments (and/or account credits), increases in the commission/donation rate for applicable sales leads and/or the like.

Subsequent to the registration of a sales lead, the provider can initiate a proposed transaction with the sales lead (block 355). Generally, initiation of a proposed transaction can comprise contacting the sales lead using the contact information (and, in particular cases, using the preferred contact method in the sales lead's registration) to propose a transaction whereby the sales lead purchases products under the fund raising program. The initiation of the proposed transaction can take a variety of forms. It may be relatively specific, identifying particular products (and, optionally, prices) that the sales lead committed to purchasing when originally contacted by the organization. Alternatively, it may be more general, e.g., simply inviting the sales lead to engage in a transaction with the provider in order to raise funds for the organization. In particular cases, the organization and/or the member who registered the lead can be referenced in the communication initiating the proposed transaction, in order to benefit from the personal relationship/goodwill enjoyed by that organization/member and/or remind the sales lead of the purpose of the provider's communication. In this way, for instance, the provider can avoid the appearance of “spam” or “cold calling” when attempting to initiate a proposed transaction.

The type of communication used to initiate the proposed transaction can vary according to implementation. Merely by way of example, the contact method may be via telephone, and the transaction may be conducted (if accepted by the sales lead) during the telephone call, as described in greater detail below. The telephone contact may be performed via IVR and/or DTMF interpretation and/or by a person. As another example, the contact method can be electronic mail, the sales lead may be offered a link to a web site where the sales lead may purchase the products and/or a telephone number the sales lead can call to perform a telephonic transaction. In some cases, the contact initiating the proposed transaction can include a transaction identifier, which can be, for example, any string used to identify the proposed transaction and/or the sales lead.

If the sales lead elects to engage in a transaction to purchase services under the fundraising program, the transaction may be conducted, in some cases by using a processing system to facilitate the transaction. For instance, as mentioned above, the sales lead may choose to engage in a transaction by accessing a web page (perhaps in response to receiving an electronic message, postal message, flyer, etc. with a link to that web page) operated by and/or on behalf of the provider (and perhaps running on the processing system and/or another computer in communication with the processing system). The web page can allow the sales lead to provide the necessary information for the transaction (contact information, payment method, etc.), in appropriate fields, some or all of which can be filled in by the system using the contact information. In some cases, the sales lead may be presented with an initial web page and asked for the transaction identifier mentioned above and, after providing the identifier, the sales lead can be presented with a subsequent web page, where the lead can provide/confirm transaction details, such as product(s) purchased, price, delivery options, etc. In some such cases, the system, in response to the transaction identifier, can access information about the sales lead, proposed transaction and/or fundraising program related to that identifier, allowing for correlation of the transaction with the appropriate organization as well as, optionally, the automatic population of fields on the subsequent web page.

In other embodiments, the transaction may be conducted by telephone, optionally as part of the contact initiating the sales transaction, using an IVR and/or DTMF interpretation and/or a live operator who can obtain transaction details from the sales lead. In yet further embodiments, the transaction may be conducted in other ways, including without limitation by fax, postal mail and/or in person. No matter how conducted, however, the transaction may utilize a transaction identifier.

In some cases, the products to be purchased may be specified as part of the fundraising program and/or by the organization/member registering the contact information. Merely by way of example, when the sales lead was first contacted by the organization, the sales lead may have indicated a willingness/commitment to purchase certain products and, as mentioned above, the registration of that sales lead may have included an identification of those products. Those products and/or quantities may be preselected for the transaction and/or the sales lead may be allowed to change the preselected values. In other cases, however, the sales lead may be allowed to choose from among an array of products to purchase under the program (block 360). Optionally, the sales lead may be informed, for each available product, of the amount of funds that will be contributed to the organization as a result of the purchase of that product.

Once the sales lead has provided and/or confirmed the details of the transaction, the transaction may be processed (e.g., by the processing systems and/or a system in communication with the processing system) (block 365). Processing the transaction may be done while a communication (e.g., a web transaction, phone call, etc.) is ongoing and/or may be performed at a later time, perhaps as part of a batch processing of multiple transactions. Any of several methods for processing transactions, many of which are known to those skilled in the art, may be used. Merely by way of example, the transaction may comprise a credit card transaction performed via a web page, and processing the transaction can comprise performing a credit authorization and entering the sales lead's order into a transaction database, where it may subsequently be fulfilled, e.g., by shipping the ordered product(s) to an address provided by the sales lead. Alternatively, products may be billed (sometimes periodically), and no payment need be made at the time the transaction is processed. Merely by way of example, the ordered product may comprise a telecommunication service, such as wireless phone service, and processing the transaction can comprise creating an account for the service, with periodic billing (which can involve automatic payments, e.g., automatic withdrawals from a checking account and/or automatic credit card transactions, and/or traditional billing practices, which can involve paper and/or electronic statements, which the sales lead can pay according to agreed terms). In embodiments where the product involves such a service, processing the transaction can include provisioning the service, perhaps in a manner known to those skilled in the art.

Optionally, a confirmation that the transaction has been processed may be given to the sales lead, either in real time (i.e., during the communication) and/or at a subsequent time, as appropriate. The confirmation can include details relevant to the fulfillment of the product, such as courier tracking numbers, product identifiers (including, for example, a telephone number for a purchased wireless service), and the like, as well as confirmation of the payment terms (e.g., a credit card authorization code, an estimated date and/or amount of the first statement, etc.). Optionally, the confirmation can include a statement of the funds generated for the organization through the transaction, as well as, if appropriate, a statement of how much of the purchase price for the products comprises a tax-exempt donation, for the sales lead's records.

In some cases, the sales lead will be required to make a minimum commitment in order to trigger any donation under the fundraising program (block 370). The minimum commitment can take any appropriate form. Merely by way of example, if the offered products are relatively inexpensive, the sales lead may be required to purchase a minimum quantity (e.g., an absolute minimum quantity, a quantity corresponding to a minimum total sale amount, etc.) to trigger a contribution to the organization. In other cases, the product may be one that typically is purchased periodically and/or on an ongoing basis (e.g., medication, certain types of services, etc.) and the minimum commitment may comprise a commitment to purchase the products on an ongoing basis over a minimum time period. So, for example, if the offered product is pay television service, the sales lead may be required to commit to purchasing the service on an ongoing basis for a minimum duration (e.g. one year). For such products, the commitment may be formal or informal. For instance, the sales lead may be required to contract and/or pay for up front (e.g., during the transaction) the product for the entire minimum duration, or the sales lead may merely be informed that a failure to continue to purchase the product throughout the minimum duration will result in a reduction/elimination of the donation from that transaction.

In accordance with the illustrated embodiments, funds may be contributed to the organization (block 375). In some cases, the contribution of funds will occur after the transaction has been successfully processed, e.g., to ensure that the provider actually receives a valid order under the fund raising program prior to disbursing funds to the organization. In other cases (for example, if the organization receives an incentive related to sales leads registered), some or all of the applicable contribution may be made before a transaction is processed. In certain embodiments, the contribution of funds comprises crediting an account associated with the organization, such that no funds actually are exchanged at the time. On a periodic basis, then, the amount in the account may be contributed to the organization (e.g., via a daily/weekly/monthly check, wire transfer, automatic deposit, etc.), to reduce the number of contribution transactions (and thereby reduce the administrative complexity of the fund raising process for both the organization and the provider). Alternatively, contributed funds may be transmitted to the organization (via check, wire transfer, automatic deposit, etc.) on a per-transaction basis, to provide the organization with immediate (or near-immediate) access to the contributed funds.

In some cases (including those in which a minimum commitment is required to trigger a contribution, as discussed above), the contribution may be withheld from the organization until the minimum commitment has been attained, and/or the contribution can be reduced (e.g., by withdrawing funds from a contribution account) if the minimum commitment goes unfulfilled. Thus, for example, if a sales lead commits to purchase a telecommunication service for a year, the contribution may be withheld until the year's worth of service has been purchased; alternatively, a contribution may be made at the time (or shortly after) the transaction is processed, and if the sales lead cancels the service before the commitment is fulfilled, all (or a portion) of the contribution may be recovered from the organization (e.g., withdrawn from a contribution account, etc.)

The contribution can take any appropriate form. Merely by way of example, the contribution can comprise currency (dollars, etc.). In other cases, the contribution can comprise credit, which can be used to obtain the provider's products for the organization and/or its members, as allowed by applicable regulations governing charitable contributions.

Optionally, the organization may be provided with status reports (block 380). Such reports may be generated periodically by the provider and/or on demand by the organization. Merely by way of example, a monthly status report may be mailed to the organization by postal mail and/or electronic message. Alternatively, the organization may request a status report (e.g., by calling a specified telephone number and/or accessing a web site), which can then be produced in real time (e.g., spoken, perhaps by an IVR, and/or displayed on one or more web pages) and/or transmitted (e.g., by postal mail and/or electronic message) to the organization at a subsequent time. Status reports produced with manual intervention and/or incurring operating costs (paper, postage, etc.) may result in a deduction against the contributed funds (and/or a reduction rate), in order to reimburse the provider and/or provide an incentive to the organization to use electronic status reports.

The status report can comprise any information of interest to the organization about the fund raising program. Such information can include, for example, the number and/or identities of registered members, registered sales leads, transactions initiated, transactions processed, and the like. The information can further include a description of the amount and nature of products purchased (in summary fashion and/or detailed by transaction, referring member, sales lead, etc.), as well as a description of the funds generated. The status report can describe activity for a given interval (e.g., monthly updates) and/or overall.

In certain embodiments, procedures may be implemented to prevent the organization and/or its members from engaging in underhanded tactics, such as the indiscriminate registration of sales leads (e.g., by collecting electronic mail addresses of unknown persons and submitting them as sales leads). One such procedure can include taking remedial action with respect to any sales lead that is uninterested in purchasing the offered products and/or unaware of the fund raising program in which the organization is participating (block 385). Merely by way of example, if the sales lead indicates in response to the invitation (as described with respect to block 355) that he or she is uninterested in the offered products or that he or she is unaware of the reason for the invitation (e.g., by reply message, telephonic input, etc.), remedial action can be taken. In some cases, the invitation can include a disclaimer and/or instructions describing how the sales lead can provide such an indication. Merely by way of example, an electronic mail invitation may allow the sales lead to reply with such comments and/or a telephonic invitation may instruct the sales lead to press a certain key if they are unaware of the program. In some cases, the sales lead's indication may be confirmed by the provider before any remedial action is taken, to ensure that the sales lead did not merely forget about the program, etc.

Remedial action can vary according to the implementation and circumstances. Merely by way of example, the remedial action can comprise simply informing the organization that a sales lead appears to have been registered in error. In other cases (perhaps where multiple uninterested sales leads have been registered by an organization), more aggressive remedial action may be taken. For instance, the organization may be warned that submission of additional “invalid” sales leads will incur a penalty under the program and/or a penalty may be imposed. The penalty can include, inter alia, reduction in the amount of funds contributed already and/or in the future, reduction in the contribution rate, suspension of the organization's and/or certain of its members' ability to register new sales leads, termination of the fund raising program and the like.

As described herein, various embodiments of the invention provide inventive methods and systems for raising funds for a non-profit organization. The description above identifies certain exemplary embodiments for implementing the invention, but those skilled in the art will recognize that many modifications and variations are possible within the scope of the invention. The invention, therefore, is defined only by the claims set forth below.

1. In a relationship between a product provider and a non-profit organization, a system for providing funding under a fund raising program for the non-profit organization, the system comprising:
a processor;
an interface in communication with the processor, the interface being configured to interact with a user;
a computer readable medium in communication with the processor, the computer readable medium comprising instructions executable by the processor to:
accept input from a user device regarding a sales lead who may have an interest in at least one product offered by the provider;
register information about the sales lead in response to the input from the user device, the information comprising contact information about the sales lead;
contact the sales lead using the registered contact information to invite the sales lead to engage in a transaction regarding the at least one product in which the sales lead may have an interest;
if the sales lead chooses to engage in a transaction, process a transaction regarding the at least one offered product; and
if the transaction is processed, contribute funds to the non-profit organization, wherein the amount of the contribution depends on the processed transaction.

2. A system as recited in claim 1, wherein the computer readable medium further comprises instructions executable by the processor to validate the contact information for the sales lead.

3. A system as recited in claim 1, wherein contributing funds to the organization comprises providing a credit to the organization toward the purchase of products offered by the provider.

4. A system as recited in claim 1, wherein the computer readable medium further comprises instructions executable by the processor to accept a partner application from the non-profit organization prior to accepting input from a user device regarding a sales lead.

5. A system as recited in claim 1, wherein the computer readable medium further comprises instructions executable by the processor to verify a non-profit status of the non-profit organization.

6. A system as recited in claim 1, wherein the computer readable medium further comprises instructions executable by the processor to store an electronic record of the verification.

7. A system as recited in claim 1, wherein the at least one offered product is a plurality of products, wherein the computer readable medium further comprises instructions executable by the processor to allow the sales lead to choose at least one product from the plurality of products, and wherein processing an automated transaction comprises processing an automated transaction regarding the at least one chosen product.

8. A system as recited in claim 1, wherein the computer readable medium further comprises instructions executable by the processor to provide a status of the automated transaction.

9. A system as recited in claim 1, wherein the computer readable medium further comprises instructions executable by the processor to take a remedial action upon notification that the sales lead is unaware of the fund raising program.

10. A system as recited in claim 9, wherein the remedial action comprises notifying the non-profit organization that the sales lead is unaware of the fund raising program.

11. A system as recited in claim 9, wherein the remedial action comprises warning the non-profit organization that submission of additional sales leads unaware of the fund raising program will result in the imposition of a penalty against the organization.

12. A system as recited in claim 9, wherein the remedial action comprises imposing a penalty against the organization.

13. A system as recited in claim 12, wherein the penalty comprises a deduction against funds contributed to the organization.

14. A system as recited in claim 12, wherein the penalty comprises disallowing the organization or at least one of its members from submitting any additional sales leads for at least a certain period of time.

15. A system as recited in claim 12, wherein the penalty comprises terminating the organization's participation in the fund raising program.

16. A system as recited in claim 1, wherein the computer readable medium further comprises instructions executable by the processor to require a minimum commitment from the sales lead before contributing funds to the non-profit organization.

17. A system as recited in claim 16, wherein the minimum commitment comprises a minimum total product price.

18. A system as recited in claim 16, wherein the minimum commitment comprises a commitment to ongoing purchases of the offered product for a minimum duration.

19. A system as recited in claim 1, wherein the product comprises a telecommunication service.

20. A system as recited in claim 1, wherein the interface comprises a web interface.

21. A system as recited in claim 1, wherein the interface comprises a telephonic interface including an integrated voice response system.

22. A system as recited in claim 1, wherein the registered contact information for the sales lead comprises an electronic mail address, and wherein the computer readable medium further comprises instructions executable by the processor to contact the sales lead by electronic mail.

23. A system as recited in claim 22, wherein the computer readable medium further comprises instructions executable by the processor to provide an incentive to the non-profit organization for providing an electronic mail address as the contact information.

24. A system as recited in claim 1, wherein the computer readable medium further comprises instructions executable by the processor to provide an incentive to the organization, wherein the incentive is based on the sales lead information.

25. A system as recited in claim 1, wherein the registered contact information for the sales lead comprises a telephone number, and wherein the computer readable medium further comprises instructions executable by the processor to contact the sales lead by telephone.

26. In a relationship between a product provider and a non-profit organization, a method of providing funding under a fund raising program for the non-profit organization, the method comprising:
providing a computer interface between a user device and a processing system for a member of the non-profit organization to register information about a sales lead who may have an interest in at least one product offered by the provider, the information comprising contact information for the sales lead;
electronically contacting the sales lead using the registered contact information to invite the sales lead to engage in a transaction regarding the at least one offered product in which the sales lead may have an interest;
if the sales lead chooses to engage in a transaction, processing an automated transaction regarding the at least one offered product; and
if the transaction is processed, contributing funds the non-profit organization, wherein the amount of the contribution depends on the processed transaction.

27. A method as recited in claim 26, wherein, prior to providing the computer interface to register information about the sales lead, the sales lead has been contacted by the member of the organization to discuss at least one product offered by the product provider.

28. A method as recited in claim 26, wherein contributing funds to the organization comprises providing a credit to the organization toward the purchase of products offered by the provider.

29. A method as recited in claim 26, the method further comprising validating, with the processing system, the contact information for the sales lead.

30. A method as recited in claim 26, further comprising, prior to allowing a member of a non-profit organization to contact a sales lead, accepting an electronic partner application from the non-profit organization.

31. A method as recited in claim 30, further comprising verifying a non-profit status of the non-profit organization.

32. A method as recited in claim 31, further comprising storing an electronic record of the verification.

33. A method as recited in claim 26, wherein the at least one offered product is a plurality of products, the method further comprising allowing the sales lead to choose at least one product from the plurality of products, wherein processing an automated transaction comprises processing an automated transaction regarding the at least one chosen product.

34. A method as recited in claim 26, further comprising providing a status of the automated transaction.

35. A method as recited in claim 26, further comprising taking a remedial action upon receiving a notification that the sales lead is unaware of the fund raising program.

36. A method as recited in claim 35, wherein the remedial action comprises notifying the non-profit organization that the sales lead is unaware of the fund raising program.

37. A method as recited in claim 35, wherein the remedial action comprises warning the non-profit organization that submission of additional sales leads unaware of the fund raising program will result in the imposition of a penalty against the organization.

38. A method as recited in claim 35, wherein the remedial action comprises imposing a penalty against the organization.

39. A method as recited in claim 38, wherein the penalty comprises a deduction against funds contributed to the organization.

40. A method as recited in claim 38, wherein the penalty comprises disallowing the organization or at least one of its members from submitting any additional sales leads for at least a certain period of time.

41. A method as recited in claim 38, wherein the penalty comprises terminating the organization's participation in the fund raising program.

42. A method as recited in claim 26, further comprising requiring a minimum commitment from the sales lead before contributing funds to the non-profit organization.

43. A method as recited in claim 42, wherein the minimum commitment comprises a minimum total product price.

44. A method as recited in claim 42, wherein the minimum commitment comprises a commitment to ongoing purchases of the at least one offered product for a minimum duration.

45. A method as recited in claim 26, wherein the product comprises a telecommunication service.

46. A method as recited in claim 26, wherein the computer interface comprises a web interface.

47. A method as recited in claim 26, wherein the computer interface comprises a telephonic interface comprising an integrated voice response system.

48. A method as recited in claim 26, wherein the registered contact information for the sales lead comprises an electronic mail address, and wherein electronically contacting the sales lead comprises contacting the sales lead by electronic mail.

49. A method as recited in claim 48, further comprising providing an incentive to the non-profit organization if the registered contact information comprises an electronic mail address.

50. A method as recited in claim 26, further comprising providing an incentive to the organization, wherein the incentive is based on the sales lead information.

51. A method as recited in claim 26, wherein the registered contact information for the sales lead comprises a telephone number, and wherein electronically contacting the sales lead comprises contacting the sales lead by telephone.
